(19) United States
(12) Patent Application Publication
(10) Pub. No.: US 2023/0038576 A1
(43) Pub. Date: Feb. 9, 2023

(54) SURGE PROTECTION SYSTEM

(71) Applicant: PEGATRON CORPORATION, TAIPEI cITY (TW)

(72) Inventors: Hsiao-Wei Sung, Taipei City (TW); Chun-Wei Ko, Taipei City (TW); Yi-Hsuan Lee, Taipei City (TW); Liang-Cheng Kuo, Taipei City (TW)

(73) Assignee: PEGATRON CORPORATION, TAIPEI CITY (TW)

(21) Appl. No.: 17/836,844

(22) Filed: Jun. 9, 2022

(30) Foreign Application Priority Data
Aug. 3, 2021 (TW) 110128577

(51) Int. Cl. H02H 1/04; H02H 3/08

(52) U.S. Cl. CPC H02H 1/043; H02H 3/08

(57) ABSTRACT

A surge protection system is provided. The surge protection system includes an input capacitor, a surge protection circuit, and a controller. When the input voltage starts to be transmitted to the input capacitor, a surge current is generated. The surge protection circuit includes a first path and a second path. The surge protection circuit is coupled to a second end of the input capacitor via the first path, so that the surge current is transmitted via the first path. The controller is coupled to the surge protection circuit. The controller is configured to provide a control signal to the surge protection circuit to switch the first path to the second path to be coupled to the second end of the input capacitor.

### CROSS-REFERENCE TO RELATED APPLICATION

This application claims the priority benefit of Taiwan patent application no. 110128577, filed on Aug. 3, 2021. The entirety of the above-mentioned patent application is hereby incorporated by reference herein and made a part of this specification.

### BACKGROUND

### Technical Field

The disclosure relates to a protection system; more particularly, the disclosure relates to a surge protection system.

### Description of Related Art

At the moment when a charger of an electronic product is connected to a transformer, due to an instantaneous change to a voltage, the transformer generates a surge current to the electronic product. When the excessively high surge current enters the electronic product, elements of the electronic product may be damaged. Therefore, according to the related art, a back-to-back metal oxide semiconductor field effect transistor (MOSFET) may be arranged in the charger of the electronic product, and the MOSFET may serve to withstand the surge current.

However, due to the increase in the power of the electronic product, the wattage selected for the transformer accordingly increases. As a result, the surge current generated by the transformer also increases, and the volume and the cost of the back-to-back MOSFET arranged to withstand the surge current in the charger also increase correspondingly.

### SUMMARY

The disclosure provides a surge protection system capable of effectively lessening an impact of a surge current on electronic products by dividing current of a surge protection circuit.

In an embodiment of the disclosure, a surge protection system adapted to be coupled to a transformer is provided. The transformer provides an input voltage. The surge protection system includes an input capacitor, a surge protection circuit, and a controller. The input capacitor includes a first end and a second end, and the first end of the input capacitor is adapted to be coupled to the transformer and receive the input voltage. Here, when the input voltage starts to be transmitted to the input capacitor, a surge current is generated. The surge protection circuit is coupled to the second end of the input capacitor. The surge protection circuit includes a first path and a second path, and the surge protection circuit is coupled to the second end of the input capacitor via the first path, so that the surge current is transmitted via the first path. The controller is coupled to the surge protection circuit, and the controller is configured to provide a control signal to the surge protection circuit to switch the first path to the second path to be coupled to the second end of the input capacitor.

In view of the above, in the surge protection system provided in one or more embodiments of the disclosure, the surge current is divided via the first path of the surge protection circuit, and the control signal switches the first path to the second path to be coupled to the second end of the input capacitor, whereby the impact of the surge current on the electronic product may be lessened, and the power consumption of the surge protection circuit may be reduced after the surge current is divided.

To make the above more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic view of a surge protection system according to an embodiment of the disclosure.

FIG. 2 is a schematic view of a surge protection system according to an embodiment of the disclosure.

FIG. 3 is a schematic view of a surge protection system according to an embodiment of the disclosure.

FIG. 4A is a schematic view of a surge current in an electronic product which is not equipped with a surge protection system.

FIG. 4B is a schematic view of a surge current in an electronic product which is equipped with a surge protection system according to an embodiment of the disclosure.

### DESCRIPTION OF THE EMBODIMENTS

The embodiments of the disclosure are disclosed in the following drawing, and for the purpose of clarity, details for implementation are incorporated below. However, it should be understood that the practical details are not intended to limit the scope of disclosure. That is, in some embodiments of the disclosure, these details are not necessarily required. Moreover, for simplicity of the drawing, some of the conventional structures and elements are described in a simplified schematic manner.

Terminologies used herein serve to describe one or more particular embodiments of the disclosure rather than limiting the disclosure. For instance, the use of “a”, “an,” and “the” does not mean that the element referred to is singular or plural. The word “or” in the specification means “and/or”. As used herein, the terminology “and/or” includes any and all combinations of one or more of the associated items listed herein. It should also be understood that when used in this specification, the terminologies “including” or “comprising” serve to identify the existence of the features, regions, integrity, steps, operations, elements, and/or components; however, the existence or addition of one or more other features, regions, integrity, steps, operations, elements, components, and/or combinations thereof are not excluded. Moreover, the terminology “coupling” of two elements includes any direct and indirect electrical connection of two elements.

Unless defined otherwise, all terminologies (including technical and scientific terminologies) used herein denote the same meaning as commonly understood by those of ordinary skill in the pertinent art to which the application belongs. It will be further understood that the terminologies such as those defined in commonly used dictionaries should be interpreted as having meanings consistent with their meanings in the context of the related art and the disclosure, and will not be interpreted as idealized or overly formal meaning, unless explicitly defined in this specification.

It should be noted that technical features provided in several different embodiments may be replaced, recombined, and mixed in the following embodiments without departing from the spirit of the disclosure to complete other embodiments.

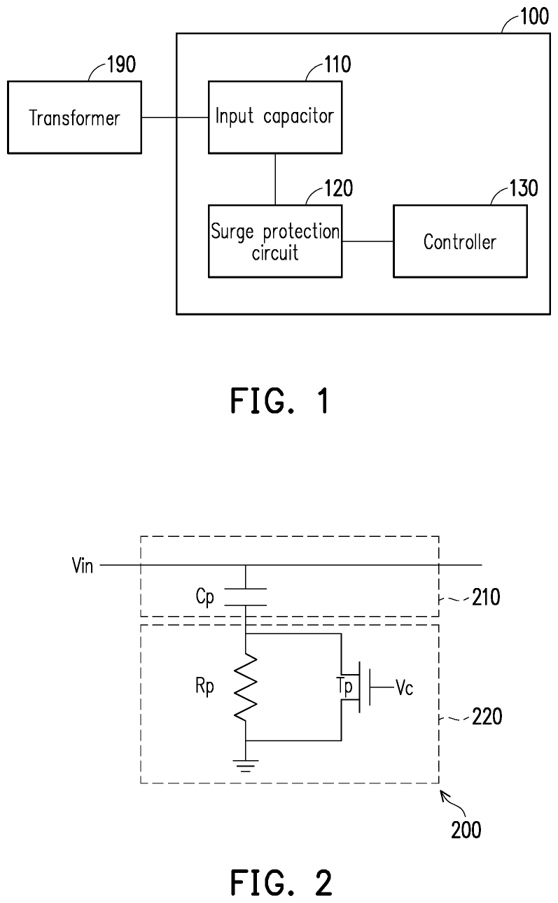

FIG. 1 is a schematic view of a surge protection system according to an embodiment of the disclosure. With reference to FIG. 1, a surge protection system 100 may be adapted to be coupled to a transformer 190. The transformer 190 may provide an input voltage (not shown). The surge protection system 100 may be disposed in an electronic product (not shown). The surge protection system 100 may include an input capacitor 110, a surge protection circuit 120, and a controller 130. The input capacitor 110 may include a first end and a second end. The surge protection circuit 120 may be coupled to the second end of the input capacitor 110. The surge protection circuit 120 may include a first path and a second path. The controller 130 may be coupled to the surge protection circuit 120. The controller 130 may be configured to transmit a control signal (not shown) to the surge protection circuit 120, so as to switch the first path to the second path to be coupled to the second end of the input capacitor 110.

In this embodiment, the input capacitor 110 may be, for instance, any capacitor configured for performing an input function in an electronic device, which should however not be construed as a limitation in the disclosure. When the transformer 190 is connected to the electronic device, the input capacitor 110 is also coupled to the transformer 190. Specifically, the first end of the input capacitor 110 may be adapted to be coupled to the transformer 190 and receive the input voltage. Besides, when the transformer 190 starts to provide the input voltage to the electronic device, due to the instantaneous change to the voltage, a surge current is generated on a path from the transformer 190 to the electronic device. In other words, when the input voltage starts to be transmitted to the input capacitor 110, the surge current may be generated. Since the surge protection circuit 120 has a certain impedance value, the surge protection circuit 120 may achieve an effect of dividing the surge current and further lessen the impact of the surge current on the electronic product.

In this embodiment, the first path has a first impedance, and the second path has a second impedance. At the moment of generating the surge current, the second end of the input capacitor 110 is coupled to the first path of the surge protection circuit 120. The surge current is transmitted via the first path of the surge protection circuit 120 to guide a part of the surge current to a reference voltage (e.g., to be grounded). Since the part of the surge current is divided by the surge protection circuit 120, the impact of the surge current on the electronic device may be effectively lessened. Besides, the first impedance of the first path at this time is less than the second impedance of the second path. After the surge current is divided, the controller 130 may switch the first path with the relatively high impedance to the second path with the relatively low impedance to be coupled the second end of the input capacitor 110, so as to reduce power consumption of the electronic products. At this time, the first impedance of the first path is greater than the second impedance of the second path. That is, at this time, the surge protection circuit 120 is coupled to the second end of the input capacitor 110 via the second path with the relatively low impedance. As such, the surge protection system 100 may receive the surge current via the first path with the relatively high impedance, so as to lessen the impact of the surge current on the electronic product. After the input current provided by the input voltage becomes stable, the surge protection system 100 may reduce the impedance via the second path with the relatively low impedance, so as to reduce the power consumption in a standby state.

In this embodiment, the electronic device may be, for instance, a mobile phone, a tablet computer, a notebook computer, a desktop computer, or any other device capable of performing a computation function, which should however not be construed as a limitation in the disclosure. In this embodiment, the controller 130 may be an existing element of the electronic device or an additional element. In this embodiment, the controller 130 may be, for instance, a central processing unit (CPU), a processor, a digital signal processor (DSP), a programmable controller, a programmable logic device (PLD), a microprocessor control unit (MCU), a field programmable gate array (FPGA), any other similar device, or a combination thereof, which should however not be construed as a limitation in the disclosure. Alternately, in an embodiment, each function of the controller 130 may be implemented in form of a plurality of programming codes. These programming codes are stored in a memory, and the controller 130 executes these programming codes. Besides, in an embodiment, each function of the controller 130 may be implemented in form of one or a plurality of circuits. The disclosure does not limit the way to implement each function of the controller 130 in form of software or hardware.

FIG. 2 is a schematic view of a surge protection system according to an embodiment of the disclosure. With reference to FIG. 1 and FIG. 2, the surge protection system 100 depicted in FIG. 1 may be implemented by the surge protection system 200 depicted in FIG. 2, which should however not be construed as a limitation in the disclosure. It should be noted that the controller 130 is omitted in FIG. 2, but FIG. 2 shows a control signal Vc provided by the controller 130. Similarly, the transformer 190 is omitted in FIG. 2, but FIG. 2 shows an input voltage Vin provided by the transformer 190.

In this embodiment, the input capacitor 210 may include a protection capacitor Cp, and the surge protection circuit 220 may include the first path and the second path. The first path has the first impedance, and the second path has the second impedance. The first path may include a protection resistor Rp, and the second path may include a protection transistor Tp. The protection capacitor Cp may include a first end and a second end. The protection resistor Rp may include a first end and a second end. The protection transistor Tp may include a first end and a second end. In this embodiment, the first end of the protection capacitor Cp is adapted to be coupled to the transformer 190 and receive the input voltage Vin. The surge protection circuit 220 is coupled to the second end of the protection capacitor Cp. Specifically, the first end of the protection resistor Rp is coupled to the second end of the protection capacitor Cp, and the second end of the protection resistor Rp is coupled to the reference voltage. In this embodiment, the reference voltage may be grounded, which should however not be construed as a limitation in the disclosure. In addition, the first end of the protection transistor Tp is coupled to the first end of the protection resistor Rp, and the second end of the protection transistor Tp is coupled to the second end of the protection resistor Rp and the reference voltage. The protection transistor Tp may further include a control end, and the control end is configured to receive the control signal Vc. In this embodiment, the control signal Vc may be configured to allow the default state of the protection transistor Tp is a switched-off state. At this time, since the protection transistor Tp is switched off, the second impedance of the second path is infinite. That is, the first impedance of the first path at this time is less than the second impedance of the second path. In addition, the control signal Vc may be configured to switch the switched-off protection transistor Tp to be switched on. At this time, since the protection transistor Tp is switched on, the second impedance of the second path is switched from being indefinite to a relatively low impedance value. In this embodiment, the second impedance of the second path including the switched-on protection transistor Tp is less than the first impedance of the first path including the protection resistor Rp.

In this embodiment, when the transformer 190 starts to provide the input voltage Vin to the electronic device, due to the instantaneous change to the voltage, the surge current is generated on the path from the transformer 190 to the electronic device. In other words, when the input voltage Vin starts to be transmitted to the protection capacitor Cp, the surge current may be generated. Since the surge protection circuit 220 has a certain impedance value, the surge protection circuit 220 may achieve the effect of dividing the surge current, which further lessens the impact of the surge current on the electronic product.

In this embodiment, the surge protection circuit 220 may be coupled to the second end of the protection capacitor Cp through the protection resistor Rp of the first path, so that the surge current is transmitted via the first path to guide a part of the surge current to the reference voltage. Since the part of the surge current is divided by the surge protection circuit 220, the impact of the surge current on the electronic device may be effectively lessened. After the surge current is divided, the control signal Vc may be configured to switch the first path to the second path of the surge protection circuit 220 to be coupled to the second end of the protection capacitor Cp. At this time, the second path is a path from the second end of the protection capacitor Cp to the reference voltage without the intervening protection resistor Rp of the first path, and thus the second impedance at this time is lower than the first impedance. In other words, the second end of the input capacitor 110 at this time is coupled to the second path of the surge protection circuit 120 with the relatively low impedance. Specifically, the control signal Vc may be configured to switch the switched-off protection transistor Tp to be switched on, so as to switch the first path with high impedance to the second path with low impedance to be coupled to the second end of the protection capacitor Cp. Therefore, the surge protection system 200 may receive the surge current through the protection resistor Rp with the relatively high impedance, so as to lessen the impact of the surge current on the electronic product. After the input current provided by the input voltage Vin becomes stable, the surge protection system 200 may reduce the impedance via the protection transistor Tp with the relatively low impedance, so as to reduce the power consumption in a standby state.

It should be explained that the impedance value of the protection resistor Rp may be adjusted according to safe operation areas (SOAs) of other elements of the electronic product. Specifically, when the upper limit of the current that the SOAs of other elements of the electronic product can withstand is high, the upper limit of the surge current that the electronic product can withstand is high. That is, when the surge current is generated, the protection resistor Rp may be configured to divide the surge current, so that a peak value of the surge current which may actually affect other elements is dropped to be equal to or lower than the upper limit of the current that the SOAs of other elements can withstand. In an embodiment, the upper limit of the current that the SOAs of other elements in the electronic product can withstand is 6 amps, while the peak value of the default surge current is 9.8 amps. In this case, if the default surge current directly enters the electronic product, other elements may be damaged accordingly. Therefore, the key factor of selecting the protection resistor Rp lies in achieving the current-dividing effect to reduce the peak value of the surge current which may actually affect other elements to be equal to or lower than 6 amps. In addition, with the change in the power of the electronic product or the wattage of the transformer 190, the protection resistor Rp may be adjusted correspondingly to achieve the sufficient current-dividing effect. For instance, when the wattage of the transformer 190 increases, the impedance of the protection resistor Rp may be correspondingly selected to be of a relatively high value, so as to achieve the better suppression effect of the surge current. When the wattage of the transformer 190 decreases, the impedance of the protection resistor Rp may be correspondingly selected to be of a relatively low value, so as to achieve the suppression effect of the surge current and reducing the cost of the surge protection system 100. That is, the impedance value of the protection resistor Rp may be determined according to the specifications of the electronic product or the specifications of the transformer 190. The protection resistor Rp may be, for instance, any electronic element with impedance characteristics, which should however not be construed as a limitation in the disclosure.

In addition, the surge current resulting from the input voltage Vin of the transformer 190 is generated at the moment when the voltage is changed. After the instantaneous moment, there will be no surge current resulting from the voltage difference on the input current corresponding to the input voltage Vin. In this embodiment, the controller 130 may be configured to switch the first path to the second path of the surge protection circuit 220 to be coupled to the second end of the protection capacitor 210 after a specific time. The specific time may be, for instance, 1 millisecond, 100 microseconds, or the like, which should however not be construed as a limitation in the disclosure.

In addition, the protection transistor Tp may be any electronic element capable of performing the switching function, and the protection transistor Tp is switched off or on through the control signal Vc. In an embodiment, the protection transistor Tp may be an n-type transistor, which should however not be construed as a limitation in the disclosure. The control signal Vc may be a square wave signal that is switched from a low potential to a high potential after a specific time, which should however not be construed as a limitation in the disclosure. That is, before the specific time, the control signal is at a low potential, and the protection transistor Tp is in a switched-off state. After the specific time, the control signal is at the high potential, and the protection transistor Tp is in a switched-on state. In another embodiment, the protection transistor Tp may be a p-type transistor, which should however not be construed as a limitation in the disclosure. The control signal Vc may be a square wave signal that is switched from a high potential to a low potential after a specific time, which should however not be construed as a limitation in the disclosure. That is, before the specific time, the control signal is at a high potential, and the protection transistor Tp is in a switched-off state. After the specific time, the control signal is at a low potential, and the protection transistor Tp is in a switched-on state. The specific time may be determined according to the description provided above and thus will not be further explained hereinafter.

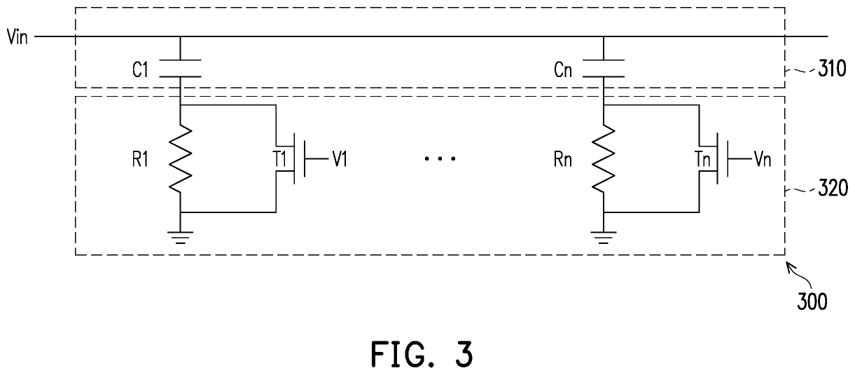

FIG. 3 is a schematic view of a surge protection system according to an embodiment of the disclosure. With reference to FIG. 1 to FIG. 3, the surge protection system 100 depicted in FIG. 1 may be implemented by the surge protection system 300 depicted in FIG. 3, which should however not be construed as a limitation in the disclosure. Note that the difference between FIG. 3 and FIG. 2 lies in that the number of the protection capacitor Cp, the number of the protection resistor Rp, and the number of the protection transistor Tr in FIG. 2 are respectively one, while the input capacitor 310 in FIG. 3 includes N protection capacitors C1 to Cn, and the surge protection circuit 320 in FIG. 3 includes N protection resistor R1 to Rn and N protection transistors Tn, where N is an integer greater than one. Other relevant details may be derived from the description depicted in FIG. 2 and will not be further explained hereinafter.

In this embodiment, the surge protection system 300 may apply N capacitors of the electronic product configured for performing an input function as the input capacitor 310. Specifically, the input capacitor 310 may include N protection capacitors C1 to Cn. Each of the N protection capacitors C1 to Cn has a first end and a second end. The surge protection circuit 320 may include N first paths and N second paths. The N first paths may include N protection resistors R1 to Rn. The number of the protection resistors R1 to Rn is N. Each of the N first paths includes one of the N protection resistors R1 to Rn. Each of the N protection resistors R1 to Rn may be coupled between the second end of a corresponding protection capacitor of the N protection capacitors C1 to Cn and the respective reference voltage. In addition, the N second paths may include N protection transistors T1 to Tn. The number of the protection transistors T1 to Tn is N. Each of the N second paths includes one of the N protection transistors T1 to Tn. Each of the N protection transistors T1 to Tn may be coupled to a corresponding N protection resistor of the N protection resistors R1 to Rn and the respective reference voltage.

In this embodiment, each of the N protection transistors T1 to Tn has a control end. Each control end of the N protection transistors T1 to Tn may be configured to receive corresponding one of the N control signals V1 to Vn. In an embodiment, the N control signals V1 to Vn may be configured to simultaneously switch the N first paths to the N second paths of the surge protection circuit 320 to be coupled to the second ends of the N protection capacitors C1 to Cn.

In another embodiment, the N control signals V1 to Vn may be configured to sequentially switch the N first paths to the N second paths of the surge protection circuit 320 to be coupled to the second ends of the N protection capacitors C1 to Cn. In still another embodiment, the N control signals V1 to Vn may be configured to switch the N first paths to the N second paths of the surge protection circuit 320 in groups to be coupled to the second ends of the N protection capacitors C1 to Cn. Therefore, the surge protection system 300 may receive the surge current via the N first paths with the relatively high impedance, so as to lessen the impact of the surge current on the electronic product. Besides, after the input current provided by the input voltage Vin becomes stable, the surge protection system 300 may reduce the impedance via the N second paths with the relatively low impedance, so as to reduce the power consumption in a standby state.

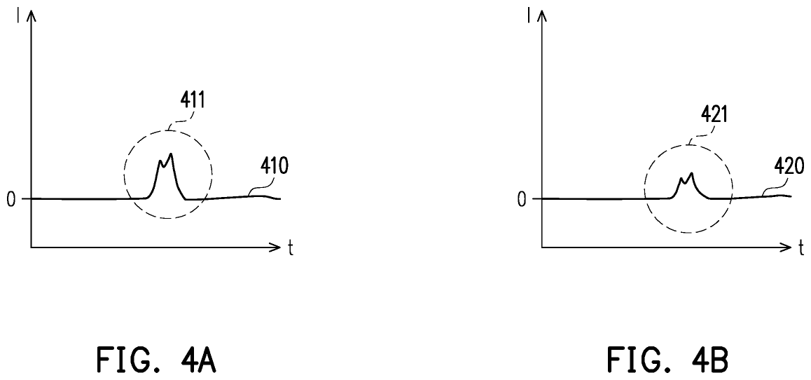

FIG. 4A is a schematic view of a surge current in an electronic product which is not equipped with a surge protection system. With reference to FIG. 1 and FIG. 4A, the horizontal axis in FIG. 4A represents time t, and the vertical axis represents current I. When the transformer 190 starts to provide the input voltage to the electronic product which is not equipped with the surge protection system 100, the input voltage generates a corresponding input current 410. Due to the instantaneous change to the voltage, the input current 410 includes a surge current 411. Since the electronic product is not equipped with the surge protection system 100, the generated surge current 411 is completely transmitted to the electronic product. When a peak value of the surge current 411 is greater than the upper limit of the current that the SOA of a certain element of the electronic product can withstand, the element may be damaged accordingly.

FIG. 4B is a schematic view of a surge current in an electronic product which is equipped with a surge protection system according to an embodiment of the disclosure. With reference to FIG. 1, FIG. 4A, and FIG. 4B, the horizontal axis in FIG. 4B represents time t, and the vertical axis represents current I. When the transformer 190 starts to provide the input voltage to the electronic product equipped with the surge protection system 100, the input voltage generates a corresponding input current 420. Due to the instantaneous change to the voltage, the input current 420 includes a surge current 421. Since the electronic product is equipped with the surge protection system 100, it is worth noting that a peak value of the surge current 421 may be effectively reduced. The peak value of the surge current 421 is lower than the peak value of the surge current 411. Therefore, the elements of the electronic product may be protected by the surge protection system 100 from being damaged by the surge current.

To sum up, in the surge protection system provided in one or more embodiments of the disclosure, the input capacitor is coupled to the protection resistor, so as to lessen the impact of the surge current on the electronic product. Moreover, when the input current provided by the input voltage becomes stable, the input capacitor may be switched to be coupled to the protection transistor, so as to reduce the impedance and the power consumption when the system is in the standby state.

It will be apparent to those skilled in the art that various modifications and variations can be made to the disclosed embodiments without departing from the scope or spirit of the disclosure. In view of the foregoing, it is intended that the disclosure covers modifications and variations provided they fall within the scope of the following claims and their equivalents.

What is claimed is:

1. A surge protection system adapted to be coupled to a transformer, the transformer providing an input voltage, the surge protection system comprising:
an input capacitor, comprising a first end and a second end, the first end of the input capacitor being adapted to be coupled to the transformer and receive the input voltage, wherein when the input voltage starts to be transmitted to the input capacitor, a surge current is generated;
a surge protection circuit, coupled to the second end of the input capacitor, the surge protection circuit comprising a first path and a second path, wherein the surge protection circuit is coupled to the second end of the input capacitor via the first path, so that the surge current is transmitted via the first path; and
a controller, coupled to the surge protection circuit, wherein the controller is configured to provide a control signal to the surge protection circuit to switch the first path to the second path to be coupled to the second end of the input capacitor.

2. The surge protection system according to claim 1, wherein the first path comprises a protection resistor, the protection resistor comprises a first end and a second end, the first end of the protection resistor is coupled to the second end of the input capacitor, and the second end of the protection resistor is coupled to a reference voltage.

3. The surge protection system according to claim 2, wherein the second path comprises a protection transistor, the protection transistor comprises a first end and a second end, the first end of the protection transistor is coupled to the first end of the protection resistor, and the second end of the protection transistor is coupled to the second end of the protection resistor and the reference voltage.

4. The surge protection system according to claim 3, wherein the protection transistor comprises a control end configured to receive the control signal.

5. The surge protection system according to claim 4, wherein the control signal switches the switched-off protection transistor to be switched on, so that the surge protection circuit is switched from the first path to the second path to be coupled to the second end of the protection capacitor.

6. The surge protection system according to claim 1, wherein the input capacitor comprises N protection capacitors, wherein N is an integer greater than one, the N protection capacitors are coupled to the transformer in parallel, each of the N protection capacitors has the first end and the second end, the number of the first path of the surge protection circuit is N, and the number of the second path of the surge protection circuit is N.

7. The surge protection system according to claim 6, wherein each of the N first paths comprises a protection resistor, and each of the protection resistors is coupled between the second end of a corresponding protection capacitor of the protection capacitors and a reference voltage.

8. The surge protection system according to claim 7, wherein each of the N second paths comprises a protection transistor, and each of the protection transistors is coupled to a corresponding protection resistor of the projection resistors and the reference voltage.

9. The surge protection system according to claim 6, wherein the control signal is configured to simultaneously switch the N first paths to the N second paths to be coupled to the second ends of the N protection capacitors.

10. The surge protection system according to claim 6, wherein the control signal is configured to sequentially switch the N first paths to the N second paths to be coupled to the second ends of the N protection capacitors.

11. The surge protection system according to claim 1, wherein the controller provides the control signal to the surge protection circuit after a specific time, so as to switch the first path to the second path to be coupled to the second end of the input capacitor.
